(19) United States
(12) Patent Application Publication
(10) Pub. No.: US 2006/0228172 A1
(43) Pub. Date: Oct. 12, 2006

(54) Furniture support system and method of making furniture

(76) Inventors: Francesco Gillia, Lima, MT (US); Marco Gillia, Lima, MT (US)

Correspondence Address: MICHAEL R. MCKENNA, 500 WEST MADISON ST., SUITE 3800, CHICAGO, IL, 60661, US

(21) Appl. No.: 11/099,852

(22) Filed: Apr. 6, 2005

(51) Int. Cl. H01R 13/53

(52) U.S. Cl. 403/355

(57) ABSTRACT

A furniture support system comprising a unique connector, locking element and base for creating a joint to securely support a table top without tools being required.

The applicant claims the benefit of the following prior filed Provisional Application, U.S. Ser. No. 60/684,000, filed Jan. 28, 2005, by the same inventors: Francesco Gillia and Marco Gillia.

### BACKGROUND OF THE INVENTION

A furniture support system is taught by the present application which comprises a connector, a locking element, a receptor and a secured member. The connector has a head extending from an elongated body. The elongated body has a first portion with a first passageway. The locking element may have a number of different shapes, but it is preferably longitudinally tapered. The receptor has a second passageway interconnected to two third passageways. The second passageway is adapted for receiving the first portion of the elongated body and for aligning the first passageway with the third passageways so that the locking element can be disposed within the third passageways and the first passageway. The secured member has a forth passageway for receiving the connector.

In this way, the fourth passageway can be aligned with the second passageway and the connector can be inserted into an alignment of the fourth passageway and the second passageway, the first passageway can be aligned with the third passageways, and the locking element can be inserted into an alignment of the first passageway and the third passageways to join the receptor to the secured member to form the furniture support system.

A preferred furniture support system comprises at least one connector having a head extending from an elongated body with a first portion with a first passageway, a locking element, a receptor and a secured member. The receptor has a second passageway and two third passageways. The second passageway is adapted for receiving the first portion of the elongated body of each of the at least one connector and for allowing alignment therein of the first passageway of each of the at least one connector with each of the at least one third passageway so that the locking element can be inserted into each of the two third passageways and the first passageway of each of the at least one connector. The secured member has at least one fourth passageway equal in number to the number of said at least one connector for receiving the connector.

Whereby, at least a portion of the head of each of the at least one connector can be engagingly inserted into one of the at least one fourth passageway with at least a portion of the elongated body of each of the at least one connector being disposed in the second passageway. Moreover, the first passageway of each of the at least one connector can be aligned with each of the two third passageways, and the locking element can be inserted into each of the two third passageways and the first passageway of each of the at least one connector to join the receptor to the secured member to form the furniture support system.

Various methods for producing a furniture support system of a connector, a locking element, a receptor, and a secured member are disclosed. A preferred method includes the steps of inserting a first portion with a first passageway of an elongated body of a connector having a head through a fourth passageway of a secured member, arranging the connector and the secured member combination so that the first passageway of the connector faces the same direction as a third passageway of a receptor that has a second passageway adapted for receiving the first portion of the elongated body of the connector, inserting the first portion extending through the fourth passageway with the first passageway of the connector facing the same direction as the third passageway into the second passageway of the receptor, aligning the first passageway of the connector generally with the third passageway of the receptor, and inserting the locking element securely into an alignment of the first passageway and the third passageway to produce the furniture support system with an interconnected connector, locking element, receptor and secured member. Alternative methods and systems for making a furniture joint and assembling a table are available in U.S. Pat. No. 3,485,527 issued in 1969 to Barghout for a chair comprising two pieces connected together by a retainer and a pin; as well as a detachable table leg attached to a table by a screw and pin connection as disclosed in U.S. Pat. No. 240,668 which issued in 1881 to Curry. A table or stool with separable interlocking components is taught by U.S. Pat. No. 4,191,113 which issued to Hogberg in 1980 and U.S. Pat. No. 4,208,850 issued to Collier in 1980 discloses a pin connection for a knock-down cabinet.

See also, U.S. Pat. No. 4,585,365 which issued in 1986 to Manno for a post and beam construction for an article of furniture, and U.S. Pat. No. 4,650,263 which issued in 1987 to Monaghan et al. for a structural support and thin panel assembly with interlocking members. Moreover, see U.S. Pat. No. 6,675,979 for a furniture assembly system having interconnecting pieces was issued to Taylor in 2004. The principal disadvantage of such devices are their cost, difficult assembly techniques, and the need for tools during assembly.

The citation of the foregoing publications is not an admission that any particular publication constitutes prior art, or that any publication alone or in conjunction with others, renders unpatentable any pending claim of the present application. None of the cited publications is believed to detract from the patentability of the claimed invention.

### ADVANTAGES OF THIS INVENTION

Unlike the foregoing devices which teach structures that require tools for assembly, this instant invention can be erected by hand without any tools whatsoever. Moreover, each of the components is or can be made relatively flat so that the system can be easily packaged and shipped. Customers of the products, made with this system will appreciate that it can be easily dis-assembled and stored or shipped to another location.

These together with other objects of the invention, along with the various features of novelty which characterize the invention are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

Still other advantages will be apparent from the disclosure that follows.

### SUMMARY OF THE INVENTION

The invention relates to a furniture support system comprising a connector, a locking element, a receptor and a secured member to form the furniture support. The unique connector has a head extending from an elongated body which has a first portion having a first transverse passageway. The unique receptor has a second passageway interconnected to two third passageways and the second passageway is adapted for receiving the first portion of the elongated body so that the first passageway can be aligned with each of the third passageways to allow the locking element to be disposed in the third passageways and the first passageway. The secured member has a forth passageway for receiving the connector and the fourth passageway can be generally aligned with the second passageway so that the connector can be inserted into an alignment of the fourth passageway and the second passageway so that the first passageway is aligned with the third passageways, and at least a segment of the locking element can be inserted into an alignment of the first passageway and the third passageways to join the receptor to the secured member to form the furniture support system.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWING

Preferred embodiments of the invention are described hereinafter with reference to the accompanying drawing wherein:

FIG. 1 is a perspective exploded view of a connector, a locking element, a receptor and a secured member of the furniture support system of the present application with the elongated body of the connector aligned for insertion into the fourth passageway of the secured element and the second passageway of the receptor, and the locking element aligned for insertion into the third passageways of the receptor, with the receptor being a leg and the secured element being a table top and each of the elongated body and the locking element having a rectangular cross-section.

FIG. 2 is a perspective exploded view of a connector, a locking element, a receptor and a secured member of the furniture support system of the present application with the elongated body of the connector aligned for insertion into the fourth passageway of the secured element and the second passageway of the receptor, and the locking element aligned for insertion into the third passageways of the receptor, with the receptor being a leg and the secured element being a table top and the elongated body having a circular cross-section and the locking element having a rectangular cross-section.

FIG. 3 is a perspective exploded view of a connector, a locking element, a receptor and a secured member of the furniture support system of the present application with the elongated body of the connector aligned for insertion into the fourth passageway of the secured element and the second passageway of the receptor, and the locking element aligned for insertion into the third passageways of the receptor, with the receptor being a leg and the secured element being a table top and the elongated body having a rectangular cross-section and the locking element having a circular cross-section.

FIG. 4 is a perspective exploded view of a connector, a locking element, a receptor and a secured member of the furniture support system of the present application with the elongated body of the connector aligned for insertion into the fourth passageway of the secured element and the second passageway of the receptor, and the locking element aligned for insertion into the third passageways of the receptor, with the receptor being a stringer and the secured element being a leg and each of the elongated body and the locking element having a rectangular cross-section.

FIG. 5 is a fragmentary perspective view of a connector, a locking element, a receptor and a secured member (shown in dashed lines) of the furniture support system of the present application with the elongated body of the connector aligned for insertion into the fourth passageway (not shown) of the secured element and the second passageway of the receptor, and the locking element aligned for insertion into the third passageways of the receptor, with the receptor being a pedestal (fragmentary top section shown) and the secured element being a table top and each of the elongated body and head of the connector being irregularly shaped as shown and the locking element having a generally flat configuration.

FIG. 6 is a perspective view of the furniture support system of FIG. 1 showing the components of the system fully engaged.

FIG. 6A is a cross-sectional view of the furniture support system of FIG. 1 showing the components of the system partially engaged.

FIG. 6B is a cross-sectional view of the furniture support system of FIG. 6 showing the components of the system fully engaged.

FIG. 7 is a perspective view of the furniture support system with a locking element of uniform cross-sectional area and a blunted nose (insertion end) showing the components of the system fully engaged.

FIG. 7A is a cross-sectional view of the furniture support system of FIG. 7 showing the components of the system partially engaged.

FIG. 7B is a cross-sectional view of the furniture support system of FIG. 7 showing the components of the system fully engaged.

FIG. 8 a perspective view of the furniture support system showing the components of the system fully engaged with the head of the connector disposed outside of the fourth passageway on top of the table top.

FIG. 8A is a cross-sectional view of the furniture support system of FIG. 8 showing the components of the system partially assembled.

FIG. 8B is a cross-sectional view of the furniture support system of FIG. 8 showing the components of the system fully assembled.

FIG. 9 is a perspective view of the furniture support system a panel leg showing the components of the system fully engaged.

FIG. 9A is a cross-sectional view of the furniture support system of FIG. 9 showing the components of the system partially engaged.

FIG. 9B is a cross-sectional view of the furniture support system of FIG. 9 showing the components of the system fully engaged.

FIG. 10 is a perspective view of the furniture support system of FIG. 4 showing the components of the system fully engaged. This series of FIGS. 10A-10D best shows how the ends of the first passageway and the third passageways are adapted to accommodate a wedge-like element.

FIG. 10A is a cross-sectional view of the furniture support system of FIG. 10 showing the components of the system partially engaged with the proximal ends of the third passageways being vertical and the opposing trailing end of the first passageway being skewed from vertical to make full contact with the wedge-like element.

FIG. 10B is a cross-sectional view of the furniture support system of FIG. 10 showing the components of the system fully engaged.

FIG. 10C is a cross-sectional view of a furniture support system similar to FIG. 10 with having a locking element showing the components of the system partially engaged with the proximal ends of the third passageways being skewed from vertical to make full contact with the wedge-like element and the opposing trailing end of the first passageway being vertical.

FIG. 10B is a cross-sectional view of the furniture support system of FIG. 10 showing the components of the system fully engaged.

FIG. 11A is a side elevation view of a furniture support system with the connector in a fully engaged position connecting a pedestal to a table top (shown in hatched lines).

FIG. 11B is an exploded side elevation view of a furniture support system of FIG. 11A with the connector, locking element and pedestal aligned for engagement with the table top removed.

FIG. 12 is a fragmentary perspective view of the furniture support system of FIG. 5 with the connector and locking element fully engaged to a table top (shown in hatched lines).

FIG. 12A is a top plan view of the top panels of the pedestal and connectors of FIG. 12 with the first passageways and the third passageways in general alignment.

FIG. 12B is a top plan view of the top panels of the pedestal and connectors of FIG. 12 with the first passageways and the third passageways securing the locking element.

FIG. 13 is a perspective view of a head of the connector showing the inner step of the head.

FIGS. 14, 14A and 14B are perspective illustrations of the interconnections of the furniture support system of FIG. 12.

FIG. 15 is a perspective illustration showing a corresponding relationship between the shape of the first passageway of the connector and the cross-sectional shape of the locking element, and further showing a variety of cross-sectionally shaped locking elements.

FIG. 16 is a perspective view of a table made using the furniture support system of the present invention and further showing that the back end of the locking element can be disposed in the third passageway.

FIG. 17 is a perspective view of another table made using the furniture support system of the present invention and further a stringer interconnecting the pedestals and locked in place with a wedge.

### DETAILED DESCRIPTION OF THE INVENTION

The preferred embodiments depicted in the drawing comprise a furniture support system comprising a connector 1, a locking element 2, a receptor 3 and a secured member 4 for securing the receptor 3 to the secured member 4.

Without departing from the generality of the invention disclosed herein and without limiting the scope of the invention, the discussion that follows, will refer to the invention as depicted in the drawing.

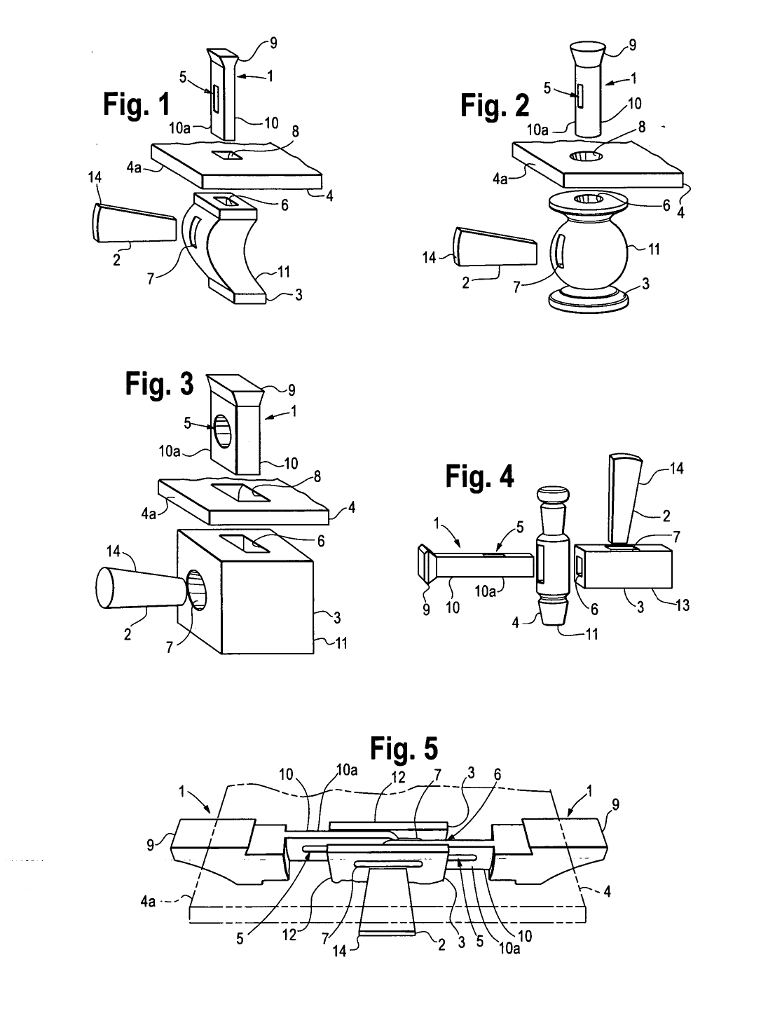

The preferred embodiments of the apparatus depicted in the drawing comprise a furniture support system comprising a connector 1, a locking element 2, a receptor 3 and a secured member 4 to form the furniture support system. The connector 1 has a head 9 extending from an elongated body 10 which has a first portion 10a with a first transverse passageway. The receptor 3 has a second passageway 6 interconnected to two third passageways 7. The second passageway 6 is adapted for receiving the first portion 10a of the elongated body 10 and for aligning the first passageway 5 with each of the third passageways 7 so that the locking element 2 can be disposed in the third passageways 7 and the first passageway 5. Referring to representative FIG. 1, the secured member 4 has a forth passageway for receiving the connector 1, so that the fourth passageway 8 can be generally aligned with the second passageway 6 and the connector 1 can be inserted into an alignment of the fourth passageway 8 and the second passageway 6 so that the first passageway 5 is aligned with the third passageways 7, and at least a segment of the locking element 2 can be inserted into an alignment of the first passageway 5 and the third passageways 7 to join the receptor 3 to the secured member 4 to form the furniture support system.

Preferably, the locking element 2 comprises an elongated wedge-shaped element 14 with an insertion end 2a that is smaller in cross-sectional area than a back end 2b, and the elongated wedge-shaped element 14 has opposing first and second surfaces, 14 a and 14b, respectively. The first passageway 5 has a leading end 5a and an opposing trailing end 5b, with the leading end 5a being closer to the head 9, the trailing end 5b of the first passageway 5 being adapted for engaging contact with one of the opposing first and second surfaces of the locking element 2, and the third passageways 7 comprise a first of the third passageways 7 and a second of the third passageways 7 that are disposed at a predetermined spaced distance from each other, both third passageways 7 have a proximal end 7a proximate a first end of the receptor 3 and a distal end 7b proximate an opposing end of the receptor 3, and each of the first of the third passageways 7 and second of the third passageways 7 are adapted to receive the elongated wedge-shaped element 14. In this way, the insertion end 2a of the elongated wedge-shaped element 14 can be inserted into the first of the third passageways 7 with the opposing first surface 14a in the direction of the proximal end 7a of the third passageways 7 and the leading end 5a of the first passageway 5, with the opposing second surface 14b of the wedge-shaped element 14 facing the direction of the opposing trailing end 5b of the first passageway 5 and the distal end 7b of the third passageways 7, and the elongated wedge-shaped element 14 can be further inserted so that the opposing first surface 14a of the wedge-shaped element 14 makes an engaging contact with the proximal end 7a of each of the first and the second of the third passageways 7, and the opposing second surface 14b of the wedge-shaped element 14 makes engaging contact with the opposing trailing end 5b of the first passageway 5 to secure the receptor 3 to the secured member 4 to form the furniture support systems.

As shown in the drawing the furniture support system of this important invention comprises at least one connector 1, a locking element 2, a receptor 3 and a secured member 4 to form the furniture support system. The at least one connector 1 has a head 9 extending from an elongated body 10, the elongated body 10 has a first portion 10a with a first passageway 5, (The term passageway as used herein means a way that permits passage between two places or points. Dictionary of Scientific and Technical Terms, McGraw-Hill, Fourth Edition.) The receptor 3 has a second passageway 6 and two third passageways 7. The second passageway 6 is adapted for receiving the first portion 10a of the elongated body 10 of each of the at least one connector 1 and for allowing general alignment therein of the first passageway 5 of each of the at least one connector 1 with each of the two third passageways 7, so that the locking element 2 can be inserted into each of the third passageways 7 and the first passageway 5 of each of the at least one connector 1. The secured member 4 has at least one fourth passageway 8 equal in number to the number of the at least one connector 1 for receiving the connector 1. Whereby, at least a portion of the head 9 of each of the at least one connector 1 can be engagingly inserted into one of the at least one fourth passageway 8 with the first portion 10a of the elongated body 10 of each of the at least one connector 1 being disposed in the second passageway 6, wherein the first passageway 5 of each of the at least one connector 1 can be generally aligned with each of the third passageways 7, and the locking element 2 can be inserted into each of the third passageways 7 and the first passageway 5 of each of the at least one connector 1 to join the receptor 3 to the secured member 4 to form the furniture support system.

Additionally, the furniture support system includes the head 9 extending longitudinally to a predetermined height from the elongated body 10. The head 9 has a maximum transverse (i.e. cross-sectional) dimension that is greater than a maximum transverse dimension of the elongated body 10. The at least one fourth passageway 8 has a minimum transverse dimension that does not substantially exceed the maximum transverse dimension of the elongated body 10, and a maximum transverse dimension that does not substantially exceed the maximum transverse dimension of the head 9. A lead in portion with a straight on distance measured along the centerline thereof between a perpendicular plane containing the maximum transverse dimension and a transverse plane that is parallel to the perpendicular plane, the transverse plane containing the minimum transverse dimension that is nearest to the maximum transverse dimension, the straight on distance of each of the at least one fourth passageway 8 being not significantly less than the predetermined height of the head 9. At least a portion of the head 9 of the connector 1 can be inserted into the fourth passageway 8 of the secured member 4.

Moreover, the furniture support system of the present invention may have the head 9 extending longitudinally from the elongated body 10, the head 9 having a maximum transverse dimension that is greater than a maximum transverse dimension of the elongated body 10, the at least one fourth passageway 8 having a uniform transverse dimension that does not substantially exceed the maximum transverse dimension of the elongated body 10 and that is less than the maximum transverse dimension of the head 9.

The furniture support system may have the elongated body 10 with a transverse shape corresponding to the transverse shape of the at least one fourth passageway 8 in the transverse plane of the minimum transverse dimension. Furthermore, the transverse shape of the elongated body 10 may comprise one of a polygon, a circle and an oval. The head 9 may taper as it progresses along the longitudinal direction of the connector 1 toward the elongated body 10, and the at least one fourth passageway 8 may comprise a frustum shaped recess adapted to snugly receive the head 9.

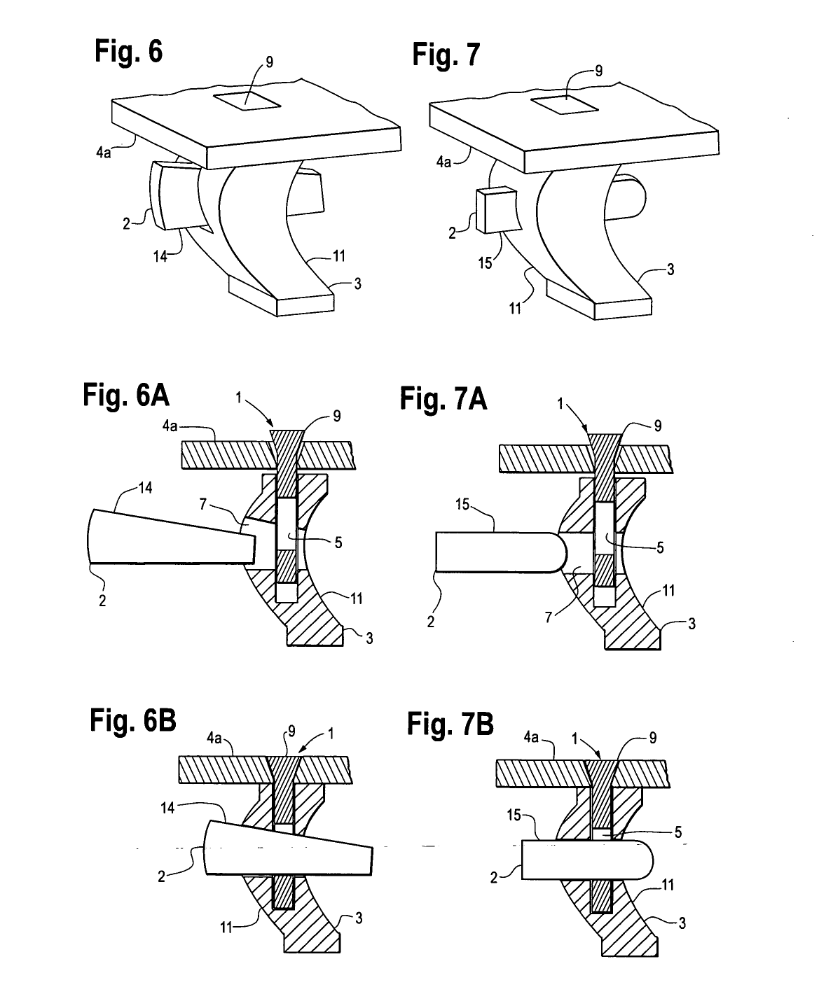

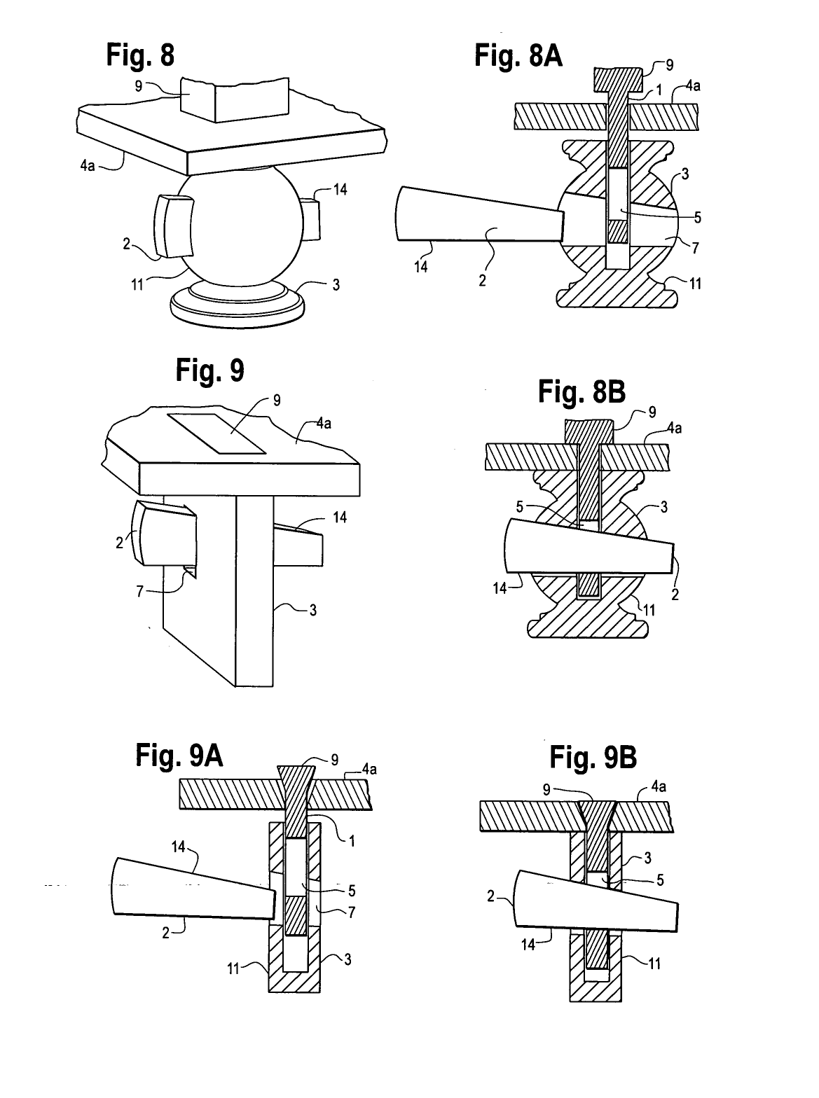

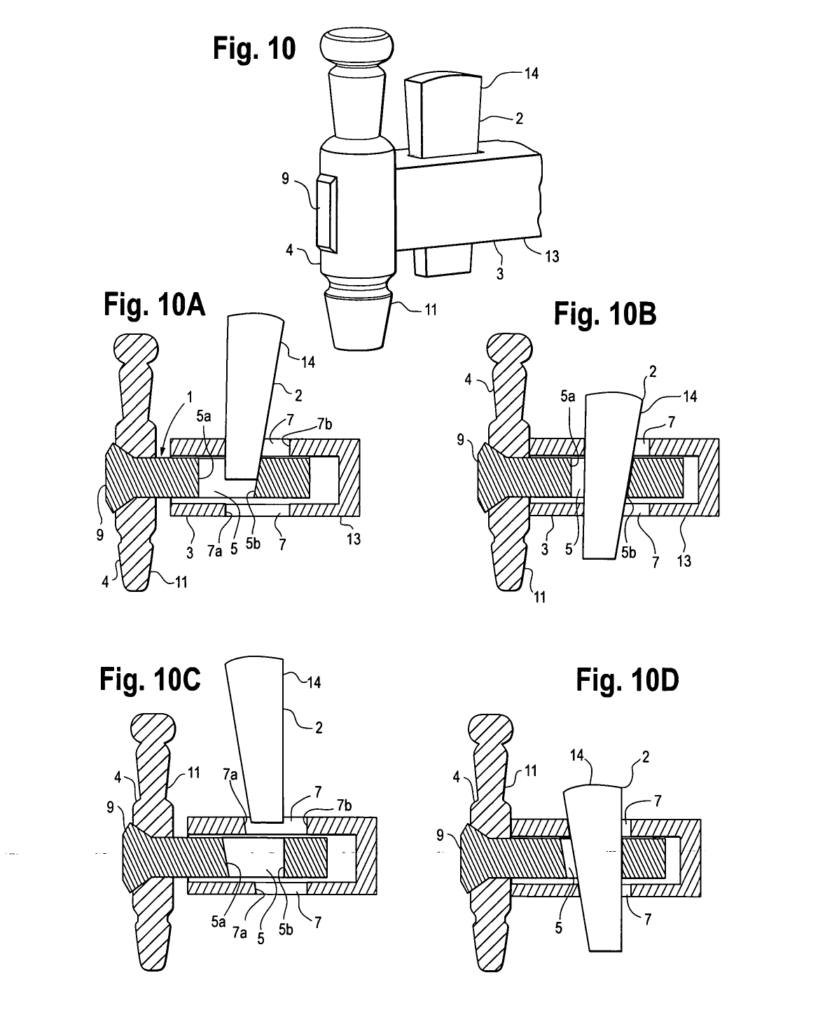

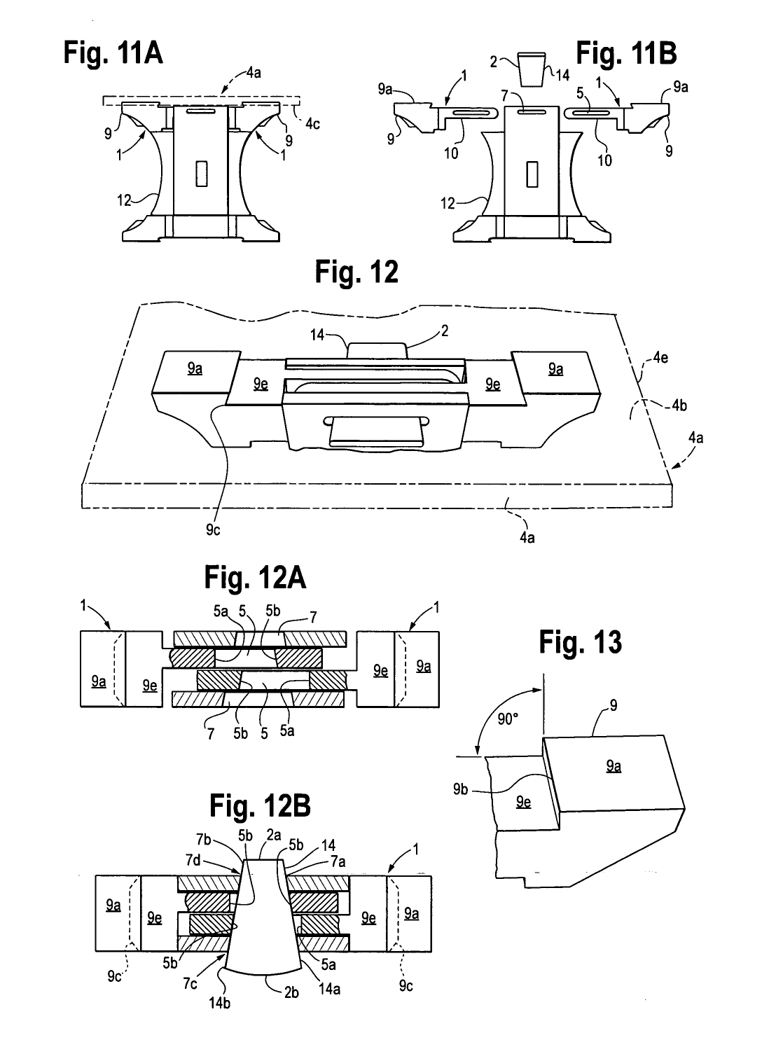

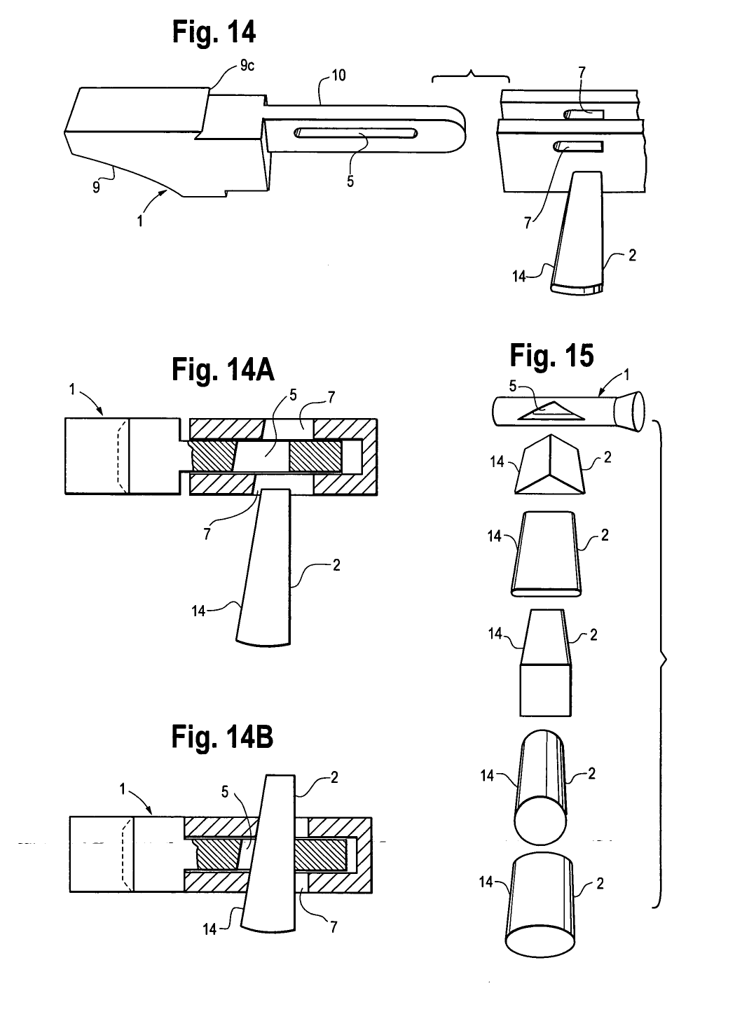

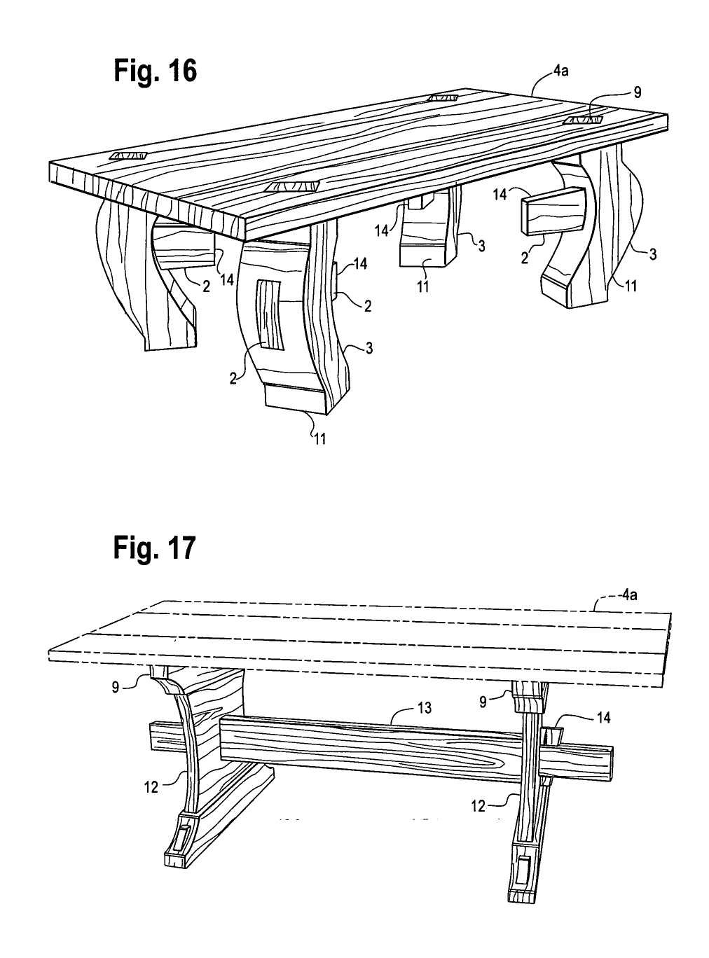

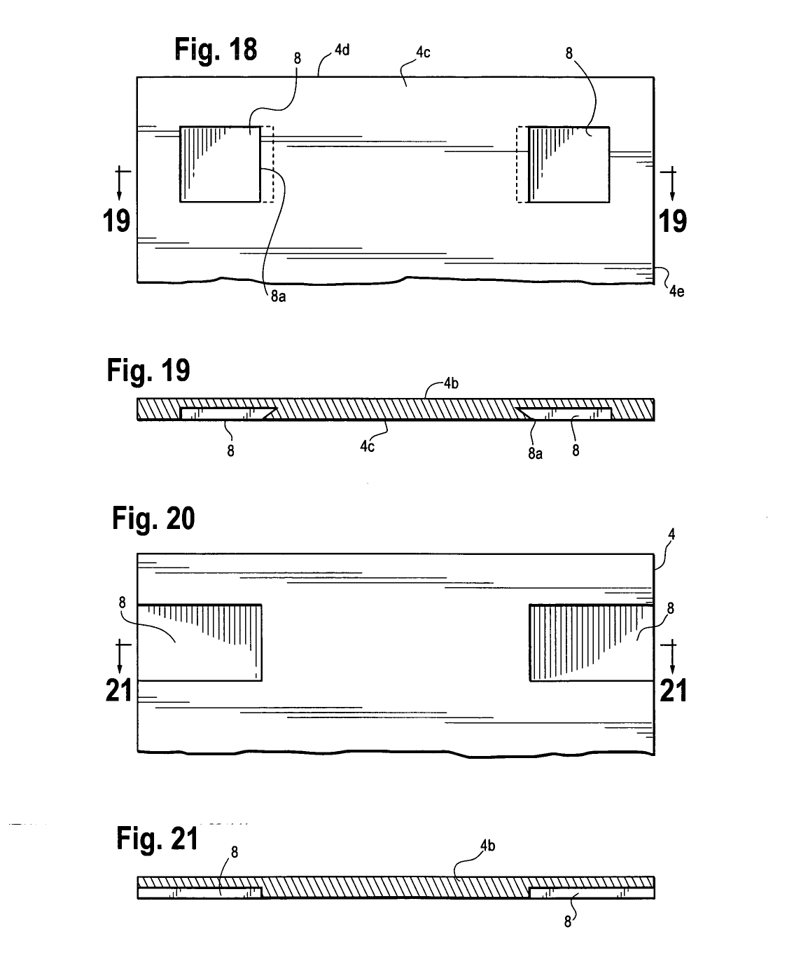

The furniture support system may use a table top 4a as the secured member 4. Moreover, the receptor 3 comprises one of a leg 11 and a pedestal 12, as shown in FIGS. 1-3 and in FIG. 5, respectively. Additionally, the secured member 4 may comprise an upright leg 11 and the receptor 3 may comprise a stringer 13, as shown in FIG. 4. The locking element 2 may comprise a wedge-shaped element 14 adapted to secure the receptor 3 to the secured member 4 to form the furniture support system as shown in FIGS. 1-6. As best shown in FIG. 15, the locking element 2 may comprise one of a frustum of a cone, a frustum of a pyramid and a paraboloidal segment.

As shown in FIGS. 1-3, 5 and 9, as well as others, the secured member 4 of the furniture support system may comprise a table top 4a with the receptor 3 comprising one of a leg 11, a panel and a pedestal 12. The head 9 may extend longitudinally from the elongated body 10 and the head 9 may have a maximum transverse dimension that is greater than a maximum transverse dimension of the elongated body 10. The at least one fourth passageway 8 may have a minimum transverse dimension that does not substantially exceed the maximum transverse dimension of the elongated body 10, and a maximum transverse dimension that does not substantially exceed the maximum transverse dimension of the head 9. The transverse shape of the elongated body 10 should correspond to the transverse shape of the at least one fourth passageway 8 in the transverse plane of the minimum transverse dimension and comprises one of a polygon, a circle and an oval, whereby, the head 9 of the connector 1 can be inserted into the fourth passageway 8 of the secured member 4.

The furniture support system preferably has a locking element 2 comprising one of a frustum of a cone, a frustum of a pyramid and a paraboloidal segment, which corresponds to the transverse shape of the elongated body 10. Additionally, the head 9 may taper as it progresses along the longitudinal direction of the connector 1 toward the elongated body 10, and the at least one fourth passageway 8 will have a frustum shaped recess adapted to snugly receive the head 9.

The furniture support system may have the secured member 4 comprising an upright leg 11 with the receptor 3 comprising a stringer 13 that extends from a first support joint to a second support joint, and the head 9 extending longitudinally from the elongated body 10 and has a maximum transverse dimension that is greater than a maximum transverse dimension of the elongated body 10. The at least one fourth passageway 8 preferably has a minimum transverse dimension that does not substantially exceed the maximum transverse dimension of the elongated body 10, and a maximum transverse dimension that does not substantially exceed the maximum transverse dimension of the head 9, and the elongated body 10 corresponds to the transverse shape of the at least one fourth passageway 8 in the plane of the minimum transverse dimension and comprises one of a polygon, a circle and an oval, that corresponds to the transverse shape of the elongated body 10. In this way, the head 9 of the connector 1 can be inserted into the fourth passageway 8 of the secured member 4.

The furniture support system may have the secured member 4 comprising a table top 4a, the receptor 3 comprising one of a leg 11 and a pedestal 12, the head 9 extending longitudinally from the elongated body 10, the head 9 having a maximum transverse dimension that is greater than a maximum transverse dimension of the elongated body 10, the at least one fourth passageway 8 having a minimum transverse dimension that does not substantially exceed the maximum transverse dimension of the elongated body 10 and a maximum transverse dimension that does not substantially exceed the maximum transverse dimension of the head 9, and the transverse shape of the elongated body 10 corresponds to the transverse shape of the at least one fourth passageway 8 in the plane of the minimum transverse dimension and comprises one of a polygon, a circle and an oval, that corresponds to the transverse shape of the elongated body 10. Whereby, the head 9 of the connector 1 can be inserted into the fourth passageway 8 of the secured member 4.

Preferably, the locking element 2 of the furniture support system comprises an elongated wedge-shaped element 14 with an insertion end 2a that is smaller in cross-sectional area than a back end 2b, and the elongated wedge-shaped element has opposing first and second surfaces; each of the first passageways 5, being a primary first passageway 5 and a secondary first passageway 5, has a leading end 5a and an opposing trailing end 5b, with the leading end 5a being closer to the head 9, the trailing end 5b of each of the first passageways 5 being adapted for engaging contact with one of the opposing first and second surfaces of the locking element 2; and each of the third passageways 7 has a proximal end 7a and a distal end 7b, with a first of the third passageways 7 being larger than a second of the third passageways 7, the first of the third passageways 7 and the second of the third passageways 7 being at a predetermined spaced distance from each other and, both third passageways have a proximal end 7a proximate a first end of the receptor 3 and a distal end 7b proximate an opposing end of the receptor 3, and each of the first of the third passageways 7 and second of the third passageways 7 are adapted to receive the elongated wedge-shaped element, so that the insertion end 2a of the elongated wedge-shaped element can be inserted into the first of the third passageways 7 with the opposing first surface 14a in the direction of the proximal end 7a of the third passageways 7 and the leading end 5a and the opposing trailing end 5b of the first passageway 5, with the opposing second surface 14b of the wedge-shaped element facing the direction of the opposing trailing end 5b of the first passageway 5 and the distal end 7b of the third passageways 7, and the elongated wedge-shaped element can be further inserted so that the opposing first surface 14a of the wedge-shaped element makes an engaging contact with the proximal end 7a of each of the first and the second of the third passageways 7, and the opposing second surface 14b of the wedge-shaped element makes an engaging contact with the opposing trailing end 5b of the first passageway 5 to secure the receptor 3 to the secured member 4 to form the furniture support systems.

As best shown in FIGS. 7-7B, the locking element 2 may comprise an elongated element 15 having a generally uniform cross-sectional area with an insertion end 2a that is blunted, and the elongated element having opposing first and second surfaces, with each of the first passageways 5, being a primary first passageway 5 and a secondary first passageway 5 and having a leading end 5a and an opposing trailing end 5b, with the leading end 5a being closer to the head 9, and with each of the leading end 5a and the trailing end 5b of each of the first passageways 5 being adapted for engaging contact with one of the opposing first and second surfaces of the locking element 2; and each of the third passageways 7 having a proximal end 7a and a distal end 7b, the first of the third passageways 7 and the second of the third passageways 7 being at a predetermined spaced distance from each other, and each being adapted to fit a segment of the locking element 2, so that the insertion end 2a of the elongated element can be inserted into the first of the third passageways 7 with the opposing first surface 14a in the direction of the proximal end 7a of the first of third passageways 7, the opposing first surface 14a of the element being in the direction of one of the leading end 5a and the opposing trailing end 5b of the primary first passageway 5, and the opposing first surface 14a of the element being in the direction of the other of the leading end 5a and the opposing trailing end 5b of the secondary first passageway 5, and the elongated element can be further inserted with the opposing first surface 14a of the elongated element in contact with the proximal end 7a and the distal end 7b of each of the first and the second of the third passageways 7, and the opposing second surface 14b of the element can be in contact with the proximal end 7a and the distal end 7b of each of the first and the second of the third passageways 7 to secure the pedestal 12 to the table top 4a to form at least one of the furniture support systems for the table.

Preferably, the furniture support system of the present invention comprises two connectors 1, a locking element 2, a receptor 3 and a secured member 4 to form the furniture support system. The two connectors 1 each have a head 9 extending from an elongated body 10 that has a first portion 10a with a first passageway 5. The receptor 3 has a second passageway 6 and two third passageways 7, with the second passageway 6 adapted for receiving the first portion 10a of the elongated body 10 of each of the two connectors 1 and for allowing alignment therein of the first passageway 5 of each of the two connectors 1 with each of the two third passageways 7, so that the locking element 2 can be inserted into each of the two third passageways 7 and the first passageway 5 of each of the two connectors 1. The secured member 4 has two fourth passageways 8—one for receiving each of the two connectors 1. Thus, at least a portion of the head 9 of each of the two connectors 1 can be engagingly inserted into one of the two fourth passageways 8 with the first portion 10a of the elongated body 10 of each of the two connectors 1 being disposed in the second passageway 6, wherein the first passageway 5 of each of the two connectors 1 can be aligned with each of the two third passageways 7, and the locking element 2 can be inserted into each of the two third passageways 7 and the first passageway 5 of each of the two connectors 1 to join the receptor 3 to the secured member 4 to form the furniture support system.

Additionally, the secured member 4 may comprise a table top 4a with a top surface 4b, a bottom surface 4c, opposing end surfaces 4d, and opposing side surfaces 4e and each head 9 may extend longitudinally from the elongated body 10 and have a protruding lateral surface 9a with an inner step 9b between the protruding lateral surface 9a and a corresponding lateral surface of the head 9. Each of the two fourth passageways 8 may comprise a recess disposed on the bottom surface 4c of the table top 4a, with each of the recesses having an inner medial edge and being adapted to receiving a portion of the head 9 with the protruding lateral surface 9a in a face to face relationship with the bottom surface of the table top 4a and the inner medial edge in a face to face relationship with the inner step 9b. The receptor 3 may have an upright pedestal 12 with a top portion have two parallel spaced apart panels with each of the panels having one of the two third passageways 7. The two third passageways 7, which may be horizontally elongated, are in general alignment with each other, and the second passageway 6 may comprise a space between the two parallel spaced apart panels.

In this way, the portion of each of the connectors 1 with the protruding lateral surface 9a disposed upwardly can be inserted into one of the two recesses with the protruding lateral surface 9a in contact with the bottom surface 4c of the table top 4a and the inner step 9b of each connector 1 in contact with the inner medial edge of each respective recess, the first portion 10a of the elongated body 10 of each of the connectors 1 can be disposed in the second passageway 6 with the first passageway 5 of the elongated body 10 of each of the connectors 1 being generally aligned with the two third passageways 7, and the locking element 2 can be inserted into each of the two third passageways 7 and the first passageway 5 of each of the two connectors 1 to join the pedestal 12 to the table top 4a to form at least one of the furniture support systems for a table. Preferably, each recess extends from one of the opposing side surfaces 4e of the table top 4a. Also, a top of each of the panels is preferably in contact with the bottom side of the table top 4a.

Furthermore, the locking element 2 may comprise an elongated wedge-shaped element that can be snugly inserted into each of the two third passageways 7 and the first passageway 5 of each of the two connectors 1 to join the receptor 3 to the secured member 4 to form the furniture support system for the table. Additionally, the locking element 2 may comprise an elongated wedge-shaped element with an insertion end 2a that is smaller in cross-sectional area than a back end 2b, and the elongated wedge-shaped element has opposing first and second surfaces (14a, 14b), each of the first passageways 5, being a primary first passageway 5 and a secondary first passageway 5, has a leading end 5a and an opposing trailing end 5b with the leading end 5a being closer to the head 9, and the trailing end 5b of each of the first passageways 5 being adapted for engaging contact with one of the opposing first and second surfaces of the locking element 2. Each of the third passageways 7 preferably has a proximal end 7a and a distal end 7b, with a first of the third passageways 7 being larger than a second of the third passageways 7, the first of the third passageways 7 and the second of the third passageways 7 being at a predetermined spaced distance from each other and being adapted to snugly fit a behind segment and a front segment of the locking element 2, respectively, so that the insertion end 2a of the elongated wedge-shaped element can be inserted into the first of the third passageways 7 with the opposing first surface 14a in the direction of the proximal end 7a of the first of third passageways 7, the opposing first surface 14a of the wedge-shaped element being in the direction of one of the leading end 5a and the opposing trailing end 5b of the primary first passageway 5, and the opposing first surface 14a of the wedge-shaped element being in the direction of the other of the leading end 5a and the opposing trailing end 5b of the secondary first passageway 5, and the elongated wedge-shaped element can be further inserted with the opposing first surface 14a of the wedge-shaped element in contact with the proximal end 7a of each of the first and the second of the third passageways 7, and the opposing second surface 14b of the wedge-shaped element can be in contact with the distal end 7b of each of the first and the second of the third passageways 7 to secure the pedestal 12 to the table top 4a to form at least one of the furniture support systems for the table.

Another preferred detail is for the inner step 9b of the head 9 to comprise a tenon 9c and the inner medial edge to comprise a mortise 8a so that a dovetail joint can be made between the head 9 and the fourth passageway 8 of the table top 4a.

The furniture support system of the present invention may further include an elongated wedge 14 have a first longitudinal dimension; a stringer 13 with a medial segment and end segments having a reduced cross-sectional area on each end, and a second pedestal 12 that is identical to the upright pedestal 12, and which is connected to the table top 4a in the same manner as the upright pedestal 12. The medial segment may have a medial transverse dimension with each of the end segments having a fifth passageway for receiving the wedge 14, and each of the pedestals 12 may have a sixth passageway for receiving one of the end segments of the stringer 13. The sixth passageway will preferably have a maximum transverse dimension that is less than the medial transverse dimension of the medial segment so that each end segment of the stringer 13 can be inserted into the sixth passageway of one of the pedestals 12 and secured in place with one of the wedges.

Moreover, the secured member 4 may comprise a table top 4a, the receptor 3 may comprise one of a leg 11 and a pedestal 12, and the head 9 may extend longitudinally from the elongated body 10. The head 9 may also have a maximum transverse dimension that is greater than a maximum transverse dimension of the elongated body 10 and the at least one fourth passageway 8 may have a minimum transverse dimension that does not substantially exceed the maximum transverse dimension of the elongated body 10 and a maximum transverse dimension that does not substantially exceed the maximum transverse dimension of the head 9, and the transverse shape of the elongated body 10 may correspond to the transverse shape of the at least one fourth passageway 8 in the transverse plane of the minimum transverse dimension and comprise one of a polygon, a circle and an oval. Whereby, the head 9 of the connector 1 can be inserted into the fourth passageway 8 of the secured member 4.

Also, the secured member 4 may comprise an upright leg 11 and the receptor 3 may comprise a stringer 13. The head 9 preferably extends longitudinally from the elongated body 10 and has a maximum transverse dimension that is greater than a maximum transverse dimension of the elongated body 10. The at least one fourth passageway 8 preferably has a minimum transverse dimension that does not substantially exceed the maximum transverse dimension of the elongated body 10, and a maximum transverse dimension that does not substantially exceed the maximum transverse dimension of the head 9, and the transverse shape of the elongated body 10 corresponds to the transverse shape of the at least one fourth passageway 8 in the plane of the minimum transverse dimension of the minimum transverse dimension and comprises one of a polygon, a circle and an oval, whereby, the head 9 of the connector 1 can be inserted into the fourth passageway 8 of the secured member 4.

Moreover, the secured member 4 may comprise a table top 4a and the receptor 3 may comprise one of a leg 11 and a pedestal 12. The head 9 may extend longitudinally from the elongated body 10 and have a maximum transverse dimension that is greater than a maximum transverse dimension of the elongated body 10. The at least one fourth passageway 8 may have a minimum transverse dimension that does not substantially exceed the maximum transverse dimension of the elongated body 10 and a maximum transverse dimension that does not substantially exceed the maximum transverse dimension of the head 9, and the transverse shape of the elongated body 10 corresponds to the transverse shape of the at least one fourth passageway 8 in the plane of the minimum transverse dimension of the minimum transverse dimension and comprises one of a polygon, a circle and an oval for the head 9 of the connector 1 to be inserted into the fourth passageway 8 of the secured member 4.

Additionally methods for producing a furniture support system for fastening a receptor 3 to a secured member 4 are taught by the present invention. One of these methods include the following steps:
a. inserting a first portion 10a with a first passageway 5 of an elongated body 10 of a connector 1 have a head 9 through a fourth passageway 8 of the secured member 4 to form a connector 1 and secured member 4 combination;
b. arranging the connector 1 and secured member 4 combination so that the first passageway 5 of the connector 1 faces the same direction as each of two third passageways 7 of the receptor 3 have a second passageway 6, that is interconnected to the two third passageways 7, adapted for receiving the first portion 10a of the elongated body 10 of the connector 1;
c. inserting the first portion 10a of the connector 1 extending from the connector 1 and secured member 4 combination into the second passageway 6 of the receptor 3;
d. aligning the first passageway 5 of the connector 1 generally with the two third passageways 7 of the receptor 3 that are interconnected to the second passageway 6 to form an alignment of the first passageway 5 and the third passageways 7; and
e. inserting a locking element 2 into the alignment of the first passageway 5 and the two third passageways 7 to secure the receptor 3 to the secured member 4 producing the furniture support system.

Another method for producing a furniture support system for fastening a receptor 3 to a secured member 4 comprises the following steps:
a. inserting a first portion 10a with a first passageway 5 of an elongated body 10 of a connector 1 have a head 9 through a fourth passageway 8 of the secured member 4 to form a connector 1 and secured member 4 combination, the first passageway 5 have a leading end 5a and an opposing trailing end 5b, with the leading end 5a being closer to the head 9, and the trailing end 5b of the first passageway 5 being adapted for engaging contact with one of an opposing first and second surfaces 14b of a locking element 2;
b. arranging the connector 1 and secured member 4 combination so that the first passageway 5 of the connector 1 faces the same direction as each of two third passageways 7 of the receptor 3 with a second passageway 6, that is interconnected to the two third passageways 7, adapted for receiving the first portion 10a of the elongated body 10 of the connector 1;
c. inserting the first portion 10a of the connector 1 extending from the connector 1 and secured member 4 combination into the second passageway 6 of the receptor 3;
d. aligning the first passageway 5 of the connector 1 generally with the two third passageways 7 of the receptor 3 that are interconnected to the second passageway 6 to form an alignment of the first passageway 5 and the third passageways 7, in which the third passageways 7 comprise a first of the third passageways 7 and a second of the third passageways 7 that are disposed at a predetermined spaced distance from each other, both third passageways 7 have a proximal end 7a proximate a first end of the receptor 3 and a distal end 7b proximate an opposing end of the receptor 3, and each of the first of the third passageways 7 and second of the third passageways 7 are adapted to receive an elongated wedge-shaped element 14; and
e. initially inserting an insertion end 2a that is smaller in cross-sectional area than a of an elongated wedge-shaped element 14 with opposing first and second surfaces into a first of the third passageways 7 with opposing first and second surfaces, the opposing first surface 14a in the direction of the proximal end 7a of the third passageways 7 and the leading end 5a of the first passageway 5, with the opposing second surface 14b of the wedge-shaped element 14 facing the direction of the opposing trailing end 5b of the first passageway 5 and the distal end 7b of the third passageways 7 of the alignment of the first passageway 5 and the two third passageways 7; and
f. making an engaging contact between the opposing first surface 14a of the wedge-shaped element 14 and the proximal end 7a of each of the first and the second of the third passageways 7, and an engaging contact between the opposing second surface 14b of the wedge-shaped element 14 and the opposing trailing end 5b of the first passageway 5 to secure the receptor 3 to the secured member 4 producing the furniture support system.

A preferred method for producing a furniture support system for fastening a pedestal 12 to a table top 4a comprises the following steps:
a. inserting a portion of a head 9 with a protruding lateral surface 9a disposed upwardly of each of two connector Is with a first passageway 5 of an elongated body 10 extending from the head 9 into one of two fourth passageways 8 comprising a recess disposed on a bottom surface 4c of the table top 4a, each the recess have an inner medial edge and being adapted to receive the portion of the head 9 with the protruding lateral surface 9a in a face to face relationship with the bottom surface of the table top 4a and with the inner medial edge in a face to face relationship with an inner step 9b between the protruding lateral surface 9a and a corresponding lateral surface 9e of the head 9;
b. making an engaging contact between the inner medial edge and the inner step 9b;
c. arranging the first portion 10a of the elongated body 10 of each of the two connectors 1 in a second passageway 6 of an upright pedestal 12 with a top portion have two parallel spaced apart panels, each of the panels have one of two third passageways 7 that are in general alignment with each other, and the second passageway 6 comprising a space between the two parallel spaced apart panels;
d. aligning the first passageway 5 of the elongated body 10 of each of the two connectors 1 generally with the two third passageways 7 of the pedestal 12; and
e. inserting a locking element 2 into each of the two third passageways 7 and the first passageway 5 of each of the two connectors 1 to join the pedestal 12 to the table top 4a to form at least one of the furniture support systems for a table.

Another preferred method for producing a furniture support system for fastening a pedestal 12 to a table top 4a, which comprises the following steps:
a. inserting a portion of a head 9 with a protruding lateral surface 9a disposed upwardly of each of two connectors 1 with a first passageway 5 of an elongated body 10 extending from the head 9 into one of two fourth passageways 8 comprising a recess disposed on a bottom surface 4c of the table top 4a, each the recess have an inner medial edge and being adapted to receive the portion of the head 9 with the protruding lateral surface 9a in a face to face relationship with the bottom surface of the table top 4a and with the inner medial edge in a face to face relationship with an inner step 9b between the protruding lateral surface 9a and a corresponding lateral surface of the head 9;
b. making an engaging contact between the inner medial edge and the inner step 9b;
c. arranging the first portion 10a of the elongated body 10 of each of the two connectors 1 in a second passageway 6 of an upright pedestal 12 with a top portion have two parallel spaced apart panels, each of the panels have one of two third passageways 7 that are in general alignment with each other, each of the two third passageways 7 have a proximal end 7a and a distal end 7b, and the second passageway 6 comprising a space between the two parallel spaced apart panels;
d. aligning the first passageway 5 of the elongated body 10 of each of the two connectors 1 generally with the two third passageways 7 of the pedestal 12, the first passageway 5 have a leading end 5a and an opposing trailing end 5b; and
e. initially inserting an insertion end 2a that is smaller in cross-sectional area than a back end 2b of an elongated wedge-shaped element 14 with opposing first and second surfaces into a first of the third passageways 7 with opposing first and second surfaces the opposing first surface in the direction of the proximal end 7a of the third passageways 7 and the leading end 5a of the first passageway 5, with the opposing second surface of the wedge-shaped element 14 facing the direction of the opposing trailing end 5b of the first passageway 5 and the distal end 7b of the third passageways 7 of the alignment of the first passageway 5 and the two third passageways 7; and
f. making an engaging contact between the opposing first surface of the wedge-shaped element 14 and the proximal end 7a of each of the first and the second of the third passageways 7, and an engaging contact between the opposing second surface of the wedge-shaped element 14 and the opposing trailing end 5b of the first passageway 5 to secure the receptor 3 to the secured member 4 producing the furniture support system.

The furniture support system can be made of standard materials including common and exotic woods, metals, plastics and other materials that could be formed to provide the elements for the system.

While this invention has been described in connection with the best mode presently contemplated by the inventor for carrying out his invention, the preferred embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

My invention resides not in any one of these features per se, but rather in the particular combinations of some or all of them herein disclosed and claimed and it is distinguished from the prior art in these particular combinations of some or all of its structures for the functions specified.

With respect to the above description then, it is to be realized that the optimum dimensional relationships for the parts of the invention, including variations in size, materials, shape, form, function and manner of operation, assembly and use, and all equivalent relationships to those illustrated in the drawings and described in the specification, that would be deemed readily apparent and obvious to one skilled in the art, are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A furniture support system comprising:
a. a connector having a head extending from an elongated body,
i. said elongated body having a first portion with a first transverse passageway;
b. a locking element;
c. a receptor having a second passageway interconnected to two third passageways,
i. said second passageway adapted for receiving the first portion of the elongated body and for aligning the first passageway with each of the third passageways so that the locking element can be disposed in the third passageways and the first passageway; and
d. a secured member having a forth passageway for receiving the connector,
whereby, the fourth passageway can be generally aligned with the second passageway and the connector can be inserted into an alignment of the fourth passageway and the second passageway so that the first passageway is aligned with the third passageways, and at least a segment of the locking element can be inserted into an alignment of the first passageway and the third passageways to join the receptor to the secured member to form the furniture support system.

2. The furniture support system of claim 1 wherein:
a. the locking element comprises an elongated wedge-shaped element with an insertion end that is smaller in cross-sectional area than a back end, and the elongated wedge-shaped element has opposing first and second surfaces;
b. the first passageway has a leading end and an opposing trailing end, with the leading end being closer to the head, said trailing end of the first passageway being adapted for engaging contact with one of the opposing first and second surfaces of the locking element; and
c. the third passageways comprise a first of the third passageways and a second of the third passageways that are disposed at a predetermined spaced distance from each other, both third passageway have a proximal end proximate a first end of the receptor and a distal end proximate an opposing end of the receptor, and each of said first of the third passageways and second of the third passageways are adapted to receive the elongated wedge-shaped element,
whereby, the insertion end of the elongated wedge-shaped element can be inserted into the first of the third passageways with the opposing first surface in the direction of the proximal end of the third passageways and the leading end of the first passageway, with the opposing second surface of the wedge-shaped element facing the direction of the opposing trailing end of the first passageway and the distal end of the third passageways, and said elongated wedge-shaped element can be further inserted so that the opposing first surface of the wedge-shaped element makes an engaging contact with the proximal end of each of the first and the second of the third passageways, and the opposing second surface of the wedge-shaped shaped element makes an engaging contact with the opposing trailing end of the first passageway to secure the receptor to the secured member to form the furniture support systems.

3. A furniture support system comprising:
a. at least one connector having a head extending from an elongated body,
i. said elongated body having a first portion with a first passageway;
b. a locking element;
c. a receptor having a second passageway and two third passageways,
i. said second passageway adapted for receiving the first portion of the elongated body of each of the at least one connector and for allowing general alignment therein of the first passageway of each of the at least one connector with each of the two third passageways, so that the locking element can be inserted into each of the third passageways and the first passageway of each of the at least one connector; and
d. a secured member having at least one fourth passageway equal in number to the number of said at least one connector for receiving the connector,
whereby, at least a portion of the head of each of the at least one connector can be engagingly inserted into one of the at least one fourth passageway with the first portion of the elongated body of each of the at least one connector being disposed in the second passageway, wherein the first passageway of each of the at least one connector can be generally aligned with each of the third passageways, and the locking element can be inserted into each of the third passageways and the first passageway of each of the at least one connector join the receptor to the secured member to form the furniture support system.

4. The furniture support system of claim 3, wherein:
a. the head extends longitudinally to a predetermined height from the elongated body;
b. the head has a maximum transverse dimension that is greater than a maximum transverse dimension of the elongated body;
c. the at least one fourth passageway has
i. a minimum transverse dimension that does not substantially exceed the maximum transverse dimension of the elongated body, and
ii. a maximum transverse dimension that does not substantially exceed the maximum transverse dimension of the head,
iii. a lead in portion with a straight on distance measured along the centerline thereof between a perpendicular plane containing the maximum transverse dimension and a transverse plane that is parallel to the perpendicular plane, said transverse plane containing the minimum transverse dimension that is nearest to the maximum transverse dimension, said straight on distance of each of the at least one fourth passageway being not significantly less than the predetermined height of the head,
whereby, at least a portion of the head of the connector can be inserted into the fourth passageway of the secured member.

5. The furniture support system of claim 3, wherein:
a. the head extends longitudinally from the elongated body;
b. the head has a maximum transverse dimension that is greater than a maximum transverse dimension of the elongated body;
c. the at least one fourth passageway has a uniform transverse dimension that does not substantially exceed the maximum transverse dimension of the elongated body and that is less than the maximum transverse dimension of the head.

6. The furniture support system of claim 4, wherein the transverse shape of the elongated body corresponds to the transverse shape of the at least one fourth passageway in the transverse plane of the minimum transverse dimension.

7. The furniture support system of claim 6, wherein the transverse shape of the elongated body comprises one of a polygon, a circle and an oval.

8. The furniture support system of claim 4, wherein the head tapers as it progresses along the longitudinal direction of the connector toward the elongated body, and the at least one fourth passageway comprises a frustum shaped recess adapted to snugly receive the head.

9. The furniture support system of claim 3, wherein the secured member comprises a table top.

10. The furniture support system of claim 9, wherein the receptor comprises one of a leg and a pedestal.

11. The furniture support system of claim 3, wherein the secured member comprises an upright leg and the receptor comprises a stringer.

12. The furniture support system of claim 11, wherein the locking element comprises a wedge-shaped element adapted to secure the receptor to the secured member to form the furniture support system.

13. The furniture support system of claim 3, wherein the locking element comprises one of a frustum of a cone, a frustum of a pyramid and a paraboloidal segment.

14. The furniture support system of claim 3, wherein:
a. the secured member comprises a table top;
b. the receptor comprises one of a leg, a panel and a pedestal;
c. the head extends longitudinally from the elongated body;
d. the head has a maximum transverse dimension that is greater than a maximum transverse dimension of the elongated body;
e. the at least one fourth passageway has
i. a minimum transverse dimension that does not substantially exceed the maximum transverse dimension of the elongated body, and
ii. a maximum transverse dimension that does not substantially exceed the maximum transverse dimension of the head, and
iii. the transverse shape of the elongated body corresponds to the transverse shape of the at least one fourth passageway in the transverse plane of the minimum transverse dimension and comprises one of a polygon, a circle and an oval,
whereby, the head of the connector can be inserted into the fourth passageway of the secured member.

15. The furniture support system of claim 14, wherein the locking element comprises one of a frustum of a cone, a frustum of a pyramid and a paraboloidal segment, which corresponds to the transverse shape of the elongated body.

16. The furniture support system of claim 4, wherein the head tapers as it progresses along the longitudinal direction of the connector toward the elongated body, and the at least one fourth passageway comprises a frustum shaped recess adapted to snugly receive the head.

17. The furniture support system of claim 3, wherein:
a. the secured member comprises an upright leg;
b. the receptor comprises a stringer that extends from a first support joint to a second support joint; and
c. the head extends longitudinally from the elongated body and has a maximum transverse dimension that is greater than a maximum transverse dimension of the elongated body;
d. the at least one fourth passageway has
i. a minimum transverse dimension that does not substantially exceed the maximum transverse dimension of the elongated body, and
ii. a maximum transverse dimension that does not substantially exceed the maximum transverse dimension of the head, and
iii. the transverse shape of the elongated body corresponds to the transverse shape of the at least one fourth passageway in the plane of the minimum transverse dimension and comprises one of a polygon, a circle and an oval, that corresponds to the transverse shape of the elongated body,
whereby, the head of the connector can be inserted into the fourth passageway of the secured member.

18. The furniture support system of claim 3, wherein:
a. the secured member comprises a table top;
b. the receptor comprises one of a leg and a pedestal;
c. the head extends longitudinally from the elongated body;
d. the head has a maximum transverse dimension that is greater than a maximum transverse dimension of the elongated body;
e. the at least one fourth passageway has
i. a minimum transverse dimension that does not substantially exceed the maximum transverse dimension of the elongated body, and
ii. a maximum transverse dimension that does not substantially exceed the maximum transverse dimension of the head, and
iii. the transverse shape of the elongated body corresponds to the transverse shape of the at least one fourth passageway in the plane of the minimum transverse dimension and comprises one of a polygon, a circle and an oval, that corresponds to the transverse shape of the elongated body,
whereby, the head of the connector can be inserted into the fourth passageway of the secured member.

19. The furniture support system of claim 3, wherein:
a. the locking element comprises an elongated wedge-shaped element with an insertion end that is smaller in cross-sectional area than a back end, and the elongated wedge-shaped element has opposing first and second surfaces;
b. each of the first passageways, being a primary first passageway and a secondary first passageway, has a leading end and an opposing trailing end, with the leading end being closer to the head, said trailing end of each of the first passageways being adapted for engaging contact with one of the opposing first and second surfaces of the locking element; and
c. each of the third passageways has a proximal end and a distal end, with a first of the third passageways being larger than a second of the third passageways, said first of the third passageways and said second of the third passageways being at a predetermined spaced distance from each other and, both third passageway have a proximal end proximate a first end of the receptor and a distal end proximate an opposing end of the receptor, and each of said first of the third passageways and second of the third passageways are adapted to receive the elongated wedge-shaped element,
whereby, the insertion end of the elongated wedge-shaped element can be inserted into the first of the third passageways with the opposing first surface in the direction of the proximal end of the third passageways and the leading end and the opposing trailing end of the first passageway, with the opposing second surface of the wedge-shaped element facing the direction of the opposing trailing end of the first passageway and the distal end of the third passageways, and said elongated wedge-shaped element can be further inserted so that the opposing first surface of the wedge-shaped element makes an engaging contact with the proximal end of each of the first and the second of the third passageways, and the opposing second surface of the wedge-shaped element makes an engaging contact with the opposing trailing end of the first passageway to secure the receptor to the secured member to form the furniture support systems.

20. The furniture support system of claim 3, wherein:
a. the locking element comprises an elongated element having a generally uniform cross-sectional area with an insertion end that is blunted, and the elongated element has opposing first and second surfaces;
b. each of the first passageways, being a primary first passageway and a secondary first passageway, has a leading end and an opposing trailing end, with the leading end being closer to the head, each of said leading end and said trailing end of each of the first passageways being adapted for engaging contact with one of the opposing first and second surfaces of the locking element; and
c. each of the third passageways has a proximal end and a distal end, said first of the third passageways and said second of the third passageways being at a predetermined spaced distance from each other, and each being adapted to fit a segment of the locking element,
whereby, the insertion end of the elongated element can be inserted into the first of the third passageways with the opposing first surface in the direction of the proximal end of the first of third passageways, the opposing first surface of the element being in the direction of one of the leading end and the opposing trailing end of the primary first passageway, and the opposing first surface of the element being in the direction of the other of the leading end and the opposing trailing end of the secondary first passageway, and said elongated element can be further inserted with the opposing first surface of the elongated element in contact with the proximal end and the distal end of each of the first and the second of the third passageways, and the opposing second surface of the element can be in contact with the proximal end and the distal end of each of the first and the second of the third passageways to secure the pedestal to the table top to form at least one of the furniture support systems for the table.

21. A furniture support system comprising:
a. two connectors each having a head extending from an elongated body,
i. said elongated body having a first portion with a first passageway;
b. a locking element;
c. a receptor having a second passageway and two third passageways,
i. said second passageway adapted for receiving the first portion of the elongated body of each of the two connectors and for allowing alignment therein of the first passageway of each of the two connectors with each of the two third passageways, so that the locking element can be inserted into each of the two third passageways and the first passageway of each of the two connectors; and
d. a secured member having two fourth passageways one for receiving each of the two connectors,
whereby, at least a portion of the head of each of the two connectors can be engagingly inserted into one of the two fourth passageways with the first portion of the elongated body of each of the two connectors being disposed in the second passageway, wherein the first passageway of each of the two connectors can be aligned with each of the two third passageways, and the locking element can be inserted into each of the two third passageways and the first passageway of each of the two connectors to join the receptor to the secured member to form the furniture support system.

22. The furniture support system of claim 21, wherein:
a. the secured member comprises a table top with a top surface, a bottom surface, opposing end surfaces, and opposing side surfaces;
b. each head extends longitudinally from the elongated body and has a protruding lateral surface with an inner step between the protruding lateral surface and a corresponding lateral surface of the head;
c. each of the two fourth passageways comprise a recess disposed on the bottom surface of the table top, each said recess has an inner medial edge and is adapted to receive a portion of the head with the protruding lateral surface in a face to face relationship with the bottom surface of the table top and the inner medial edge in a face to face relationship with the inner step;
d. the receptor comprises an upright pedestal with a top portion having two parallel spaced apart panels, each of said panels has one of the two third passageways, said two third passageways being in general alignment with each other, and the second passageway comprising a space between said two parallel spaced apart panels,
whereby, the portion of each of the connectors with the protruding lateral surface disposed upwardly can be inserted into one of the two recesses with the protruding lateral surface in contact with the bottom surface of the table top and the inner step of each connector in contact with the inner medial edge of each respective recess, the first portion of the elongated body of each of the connectors can be disposed in the second passageway with the first passageway of the elongated body of each of the connectors being generally aligned with the two third passageways, and the locking element can be inserted into each of the two third passageways and the first passageway of each of the two connectors to join the pedestal to the table top to form at least one of the furniture support systems for a table.

23. The furniture support system of claim 22, wherein each said recess extends from one of the opposing side surfaces of the table top.

24. The furniture support system of claim 22, wherein a top of each of said panels is in contact with the bottom side of the table top.

25. The furniture support system of claim 22, wherein the locking element comprises an elongated wedge-shaped element that can be snugly inserted into each of the two third passageways and the first passageway of each of the two connectors to join the receptor to the secured member to form the furniture support system for the table.

26. The furniture support system of claim 22, wherein:
a. the locking element comprises an elongated wedge-shaped element with an insertion end that is smaller in cross-sectional area than a back end, and the elongated wedge-shaped element has opposing first and second surfaces;
b. each of the first passageways, being a primary first passageway and a secondary first passageway, has a leading end and an opposing trailing end, with the leading end being closer to the head, said trailing end of each of the first passageways being adapted for engaging contact with one of the opposing first and second surfaces of the locking element; and
c. each of the third passageways has a proximal end and a distal end, with a first of the third passageways being larger than a second of the third passageways, said first of the third passageways and said second of the third passageways being at a predetermined spaced distance from each other and being adapted to snugly fit a behind segment and a front segment of the locking element, respectively,
whereby, the insertion end of the elongated wedge-shaped element can be inserted into the first of the third passageways with the opposing first surface in the direction of the proximal end of the first of third passageways, the opposing first surface of the wedge-shaped element being in the direction of one of the leading end and the opposing trailing end of the primary first passageway, and the opposing first surface of the wedge-shaped element being in the direction of the other of the leading end and the opposing trailing end of the secondary first passageway, and said elongated wedge-shaped element can be further inserted with the opposing first surface of the wedge-shaped element in contact with the proximal end of each of the first and the second of the third passageways, and the opposing second surface of the wedge-shaped element can be in contact with the distal end of each of the first and the second of the third passageways to secure the pedestal to the table top to form at least one of the furniture support systems for the table.

27. The furniture support system of claim 22, wherein the inner step of the head comprises a tenon and the inner medial edge comprises a mortise,
whereby a dovetail joint can be made between the head and the fourth passageway of the table top.

28. The furniture support system of claim 21, further comprising:
a. an elongated wedge having a first longitudinal dimension;
b. a stringer with a medial segment and end segments having a reduced cross-sectional area on each end,
i. the medial segment having a medial transverse dimension,
ii. each of the end segments having a fifth passageway for receiving the wedge; and
c. a second pedestal that is identical to the upright pedestal, and which is connected to the table top in the same manner as the upright pedestal,
i. each of said pedestals having a sixth passageway for receiving one of the end segments of the stringer, said sixth passageway having a maximum transverse dimension that is less than the medial transverse dimension of the medial segment,
whereby, each end segment of the stringer can be inserted into the sixth passageway of one of the pedestals and secured in place with one of the wedges.

29. The furniture support system of claim 21, wherein:
a. the secured member comprises a table top
b. the receptor comprises one of a leg and a pedestal;
c. the head extends longitudinally from the elongated body;
d. the head has a maximum transverse dimension that is greater than a maximum transverse dimension of the elongated body;
e. the at least one fourth passageway has
i. a minimum transverse dimension that does not substantially exceed the maximum transverse dimension of the elongated body, and
ii. a maximum transverse dimension that does not substantially exceed the maximum transverse dimension of the head, and
iii. the transverse shape of the elongated body corresponds to the transverse shape of the at least one fourth passageway in the transverse plane of the minimum transverse dimension and comprises one of a polygon, a circle and an oval,
whereby, the head of the connector can be inserted into the fourth passageway of the secured member.

30. The furniture support system of claim 21, wherein:
a. the secured member comprises an upright leg;
b. the receptor comprises a stringer;
c. the head extends longitudinally from the elongated body;
d. the head has a maximum transverse dimension that is greater than a maximum transverse dimension of the elongated body;
e. the at least one fourth passageway has
i. a minimum transverse dimension that does not substantially exceed the maximum transverse dimension of the elongated body, and
ii. a maximum transverse dimension that does not substantially exceed the maximum transverse dimension of the head, and
iii. the transverse shape of the elongated body corresponds to the transverse shape of the at least one fourth passageway in the plane of the minimum transverse dimension of the minimum transverse dimension and comprises one of a polygon, a circle and an oval,
whereby, the head of the connector can be inserted into the fourth passageway of the secured member.

31. The furniture support system of claim 21, wherein:
a. the secured member comprises a table top;
b. the receptor comprises one of a leg and a pedestal;
c. the head extends longitudinally from the elongated body;
d. the head has a maximum transverse dimension that is greater than a maximum transverse dimension of the elongated body;
e. the at least one fourth passageway has
i. a minimum transverse dimension that does not substantially exceed the maximum transverse dimension of the elongated body, and
ii. a maximum transverse dimension that does not substantially exceed the maximum transverse dimension of the head, and
iii. the transverse shape of the elongated body corresponds to the transverse shape of the at least one fourth passageway in the plane of the minimum transverse dimension of the minimum transverse dimension and comprises one of a polygon, a circle and an oval,
whereby, the head of the connector can be inserted into the fourth passageway of the secured member.

32. A method for producing a furniture support system for fastening a receptor to a secured member, which comprises the following steps:
a. inserting a first portion with a first passageway of an elongated body of a connector having a head through a fourth passageway of the secured member to form a connector and secured member combination;
b. arranging the connector and secured member combination so that the first passageway of the connector faces the same direction as each of two third passageways of the receptor having a second passageway, that is interconnected to the two third passageways, adapted for receiving the first portion of the elongated body of the connector;
c. inserting the first portion of the connector extending from the connector and secured member combination into the second passageway of the receptor;
d. aligning the first passageway of the connector generally with the two third passageways of the receptor that are interconnected to the second passageway to form an alignment of the first passageway and the third passageways; and
e. inserting a locking element into the alignment of the first passageway and the two third passageways to secure the receptor to the secured member producing the furniture support system.

33. A method for producing a furniture support system for fastening a receptor to a secured member, which comprises the following steps:
a. inserting a first portion with a first passageway of an elongated body of a connector having a head through a fourth passageway of the secured member to form a connector and secured member combination, said first passageway having a leading end and an opposing trailing end, with the leading end being closer to the head, and the trailing end of the first passageway being adapted for engaging contact with one of an opposing first and second surfaces of a locking element;
b. arranging the connector and secured member combination so that the first passageway of the connector faces the same direction as each of two third passageways of the receptor with a second passageway, that is interconnected to the two third passageways, adapted for receiving the first portion of the elongated body of the connector;
c. inserting the first portion of the connector extending from the connector and secured member combination into the second passageway of the receptor;
d. aligning the first passageway of the connector generally with the two third passageways of the receptor that are interconnected to the second passageway to form an alignment of the first passageway and the third passageways, in which the third passageways comprise a first of the third passageways and a second of the third passageways that are disposed at a predetermined spaced distance from each other, both third passageways have a proximal end proximate a first end of the receptor and a distal end proximate an opposing end of the receptor, and each of said first of the third passageways and second of the third passageways are adapted to receive an elongated wedge-shaped element; and
e. initially inserting an insertion end that is smaller in cross-sectional area than a back end of an elongated wedge-shaped element with opposing first and second surfaces into a first of the third passageways with opposing first and second surfaces the opposing first surface in the direction of the proximal end of the third passageways and the leading end of the first passageway, with the opposing second surface of the wedge-shaped element facing the direction of the opposing trailing end of the first passageway and the distal end of the third passageways of the alignment of the first passageway and the two third passageways; and
f. making an engaging contact between the opposing first surface of the wedge-shaped element and the proximal end of each of the first and the second of the third passageways, and an engaging contact between the opposing second surface of the wedge-shaped element and the opposing trailing end of the first passageway to secure the receptor to the secured member producing the furniture support system.

34. A method for producing a furniture support system for fastening a pedestal to a table top, which comprises the following steps:
a. inserting a portion of a head with a protruding lateral surface disposed upwardly of each of two connectors with a first passageway of an elongated body extending from the head into one of two fourth passageways comprising a recess disposed on a bottom surface of the table top, each said recess having an inner medial edge and being adapted to receive the portion of the head with the protruding lateral surface in a face to face relationship with the bottom surface of the table top and with the inner medial edge in a face to face relationship with an inner step between the protruding lateral surface and a corresponding lateral surface of the head;
b. making an engaging contact between the inner medial edge and the inner step;
c. arranging the first portion of the elongated body of each of the two connectors in a second passageway of an upright pedestal with a top portion having two parallel spaced apart panels, each of said panels having one of two third passageways that are in general alignment with each other, and the second passageway comprising a space between said two parallel spaced apart panels;
d. aligning the first passageway of the elongated body of each of the two connectors generally with the two third passageways of the pedestal; and
e. inserting a locking element into each of the two third passageways and the first passageway of each of the two connectors to join the pedestal to the table top to form at least one of the furniture support systems for a table.

35. A method for producing a furniture support system for fastening a pedestal to a table top, which comprises the following steps:
a. inserting a portion of a head with a protruding lateral surface disposed upwardly of each of two connectors with a first passageway of an elongated body extending from the head into one of two fourth passageways comprising a recess disposed on a bottom surface of the table top, each said recess having an inner medial edge and being adapted to receive the portion of the head with the protruding lateral surface in a face to face relationship with the bottom surface of the table top and with the inner medial edge in a face to face relationship with an inner step between the protruding lateral surface and a corresponding lateral surface of the head;
b. making an engaging contact between the inner medial edge and the inner step;
c. arranging the first portion of the elongated body of each of the two connectors in a second passageway of an upright pedestal with a top portion having two parallel spaced apart panels, each of said panels having one of two third passageways that are in general alignment with each other, each of said two third passageways having a proximal end and a distal end, and the second passageway comprising a space between said two parallel spaced apart panels;
d. aligning the first passageway of the elongated body of each of the two connectors generally with the two third passageways of the pedestal, said first passageway having a leading end and an opposing trailing end; and
e. initially inserting an insertion end that is smaller in cross-sectional area than a back end of an elongated wedge-shaped element with opposing first and second surfaces into a first of the third passageways with opposing first and second surfaces the opposing first surface in the direction of the proximal end of the third passageways and the leading end of the first passageway, with the opposing second surface of the wedge-shaped element facing the direction of the opposing trailing end of the first passageway and the distal end of the third passageways of the alignment of the first passageway and the two third passageways; and
f. making an engaging contact between the opposing first surface of the wedge-shaped element and the proximal end of each of the first and the second of the third passageways, and an engaging contact between the opposing second surface of the wedge-shaped element and the opposing trailing end of the first passageway to secure the receptor to the secured member producing the furniture support system.
